(19) United States
(12) Patent Application Publication
(10) Pub. No.: US 2022/0046906 A1
(43) Pub. Date: Feb. 17, 2022

(54) REALISTIC FLYING FISH LURE

(71) Applicant: Jazz Kramer Moorhead, Costa Mesa, CA (US)

(72) Inventor: Jazz Kramer Moorhead, Costa Mesa, CA (US)

(21) Appl. No.: 17/112,880

(22) Filed: Dec. 4, 2020

Related U.S. Application Data
(60) Provisional application No. 63/065,059, filed on Aug. 13, 2020.

(51) Int. Cl. A01K 85/08

(52) U.S. Cl. CPC A01K 85/08

(57) ABSTRACT

A realistic flying fish lure comprising a body portion and one or more detachable wings. The one or more wings are configured to be removeably engaged with the body portion, and when the one or more wings are attached to the body portion, the realistic flying fish lure is configured to resemble a California Flying Fish that is gliding above water.

### CROSS-REFERENCE TO RELATED APPLICATIONS

This Application claims the benefit of U.S. Provisional Patent Application No. 63/065,059, filed on Aug. 13, 2020, titled “REALISTIC FLYING FISH LURE,” the contents of which are expressly incorporated herein by this reference as though set forth in their entirety.

### FIELD OF USE

The present disclosure relates generally to devices, systems, and methods for fishing lures, and more specifically to a fishing lure that emulates the precise details, aesthetics, and flight characteristics of the California Flying Fish.

### BACKGROUND

When fishing, it is preferable to use a bait, live, dead, or artificial, which closely resembles the fish's normal food. There are several large predatory fish, such as Bluefin tuna that prey on the California Flying Fish. Thus, one type of lure may be a California Flying Fish, or an artificial lure that looks like a California Flying Fish. In order to resemble the California Flying Fish, the lure should also be made to mimic the movements of a California Flying Fish. The actual California Flying Fish is able to jump out of the water and glide, in a motion resembling flying, through the air above the surface of the water.

A typical flying fish may be swimming through the water and, then, in order to escape a predator, the flying fish whips its tail in a powerful rotary motion and jumps up out of the water. The airborne fish spreads its long, wing-like pectoral fins and tilts them upward, similar to a bird. Wind passing under and over the wings creates lift, which sends the fish gliding through the air. The gliding fish slaps at the water with its tail to keep the glide going. Flying fish can travel hundreds of feet through the air, skimming over the surface of the water.

When fishing for large fish, such as bluefin tuna, it is common to use a flying fish (either dead or alive) as bait. This practice is very expensive, however: due to the high prices of flying fish for use as bait, this can result in daily expenses of approximately $500-1000 in bait alone. Over the course of a fishing season, a commercial fishing operation may spend tens of thousands of dollars on flying fish to use as bait.

To reduce these very high bait costs, there have been attempts to create artificial, reusable flying fish lures. However, an artificial flying fish lure that is effective in one locale may not be effective in another, due to the fact that predators are keyed in on the specific traits of their local species. Given the wide variety of flying fish fishing fish species in existence (nearly 100), there is therefore no single flying fish lure that can act as a one-fishing-lure-fits-all solution. Although, there are some East Coast flying fish lures that are made, these are made specific to predatory fish in that region and they do not perform well when used in other environments, such as the West Coast. Furthermore, have structural flaws and break very easily in the event that they are used to catch West Coast California Flying Fish due to the aggressive nature of predatory fish.

Thus, there is a need for a realistic California Flying Fish lure that can withstand the trauma inflicted when used as bait so that it can be used as an economical and effective fishing bait substitute which performs just as well, if not better, than a real California Flying Fish.

### SUMMARY

To minimize the limitations in the cited references, and to minimize other limitations that will become apparent upon reading and understanding the present specification, the present specification discloses a new and improved realistic flying fish lure.

One embodiment may be realistic flying fish lure, comprising a body portion, which may have a tail portion and a head portion, and one or more detachable wings. The detachable wings may substantially resemble the wing-like pectoral fins of a California Flying Fish. For purposes of this disclosure, the term wings and fins are essentially interchangeable.

In one embodiment, the flying fish lure may be made of a rubber urethane blend. Preferably, the flying fish lure and its detachable wings, may be painted, airbrushed, and/or stenciled in order to more closely match the appearance of a living California Flying Fish.

In some embodiments, the flying fish lure may have a durable urethane-rubber body that can withstand repeated and violent attacks from tuna and other species of predatory fish. In some embodiments, the flying fish lure body may be manufactured by injecting a urethane-rubber blend into a mold, and curing. The urethane-rubber composition of the flying fish lure makes the flying fish lure able to skip or “fly” along the surface of the water when pulled behind a fishing boat at sufficiently high speed. Under ideal weather conditions, boat speeds of approximately 4 to 6 miles per hour may be sufficient, though this range may situationally vary depending on the wind speed and direction of travel.

In one embodiment, the flying fish lure may further comprise one or more rigid wing inserts, which may act as insertion slots for one or more detachable wings. While the majority of the body of the flying fish lure may preferably be made of a rubber urethane mixture, such a flexible material is not well suited to providing a stable attachment point for the detachable wings. As such, the one or more rigid wing inserts may provide stability and allow the one or more detachable wings to be securely attached to the main lure body. In some embodiments, the rigid wing inserts may be made of plastic. The rigid wing inserts may be placed into the fishing lure body by placing the rigid wing inserts into the lure mold before the mold is filled and cured.

In one embodiment, the detachable wings may be curved or shaped to create an airfoil shape that is configured and/or optimized to generate lift as the flying fish lure is pulled behind a boat. In a preferred embodiment, the rigid wing inserts may comprise a curved wing slot opening. The one or more detachable wings may be inserted into the curved wing slot openings within the rigid wing inserts, ensuring that the detachable wings are securely held in the proper curbed airfoil conformation for optimized lift.

In one embodiment, the one or more detachable wings may be freely removed and attached to the main lure body. In some embodiments, one or more removeable wing attachment pins may be used to secure the one or more detachable wings to the lure body, by means of one or more wing holes present in the one or more detachable wings and one or more wing pin holes present in the lure body. To attach a wing to the lure body, an insertion end of the wing may first be inserted into an exterior wing slot in the lure body, such that the wing hole vertically aligns with the wing pin hole. Placing a wing pin into the wing pin hole then secures the detachable wing into the lure body. To remove the one or more detachable wings, the above process may be performed in reverse order.

In another embodiment, the flying fish lure may further comprise a channel, which acts as a recessed slot for securing a fishing line and/or one or more hooks. The channel may run longitudinally down the length of the top portion of the lure body, approximately from the base of the head to the start of the tail. Preferably, the channel may include a J-hook recess and a treble hook recess, which allowing for one or more hooks to be slotted into the channel along with the fishing line. In another embodiment, the flying fish lure may further comprise a line guide loop, which allows the flying fish lure to freely move up the fishing line while being reeled in after a fish has taken the lure as bait.

In one embodiment, the flying fish lure of the present disclosure may be used as part of a kite fishing system. The flying fish lure may be trolled behind a boat, wherein a specialized fishing kite, equipped with a tension release clip, may be used to apply vertical lift to a fishing line attached to the flying fish lure. As the flying fish lure is trolled behind the boat via the kite system, the kite and the one or more detachable wings generate lift, causing the lure to “fly” in a manner emulating the swimming patterns of a real-life flying fish.

The flying fish lure of the present disclosure combines functional features and life-like realism to provide an effective replica of a living California Flying Fish, which act as an irresistible lure for Bluefin Tuna. By way of example, and not by limitation, these life-like features may include:
A flexible and ultra-durable, urethane-rubber body. The lure body may preferably be molded to match the size and dimensions of a real flying fish. The urethane-rubber composition of the lure body allows the lure to endure the wear and tear of even multiple seasons of fishing (such as bites from predators), providing substantial improvements to currently existing, less-durable lures.
A long-lasting paint scheme that realistically mimics the appearance of a California Flying

Fish. By using an airbrush paint process, as preferred, the flying fish lure of the present disclosure may be painted in a lifelike manner that is also durable enough to withstand the elements, such as wind and sea water, and abuse from fish teeth. While painting on urethane rubber surfaces is often difficult due to the small number of paints that adhere to it, the methods of the present disclosure use urethane airbrush painting to ensure a convincing paint job.
A removable and replaceable wing slot system. The wing slot system of the present disclosure allows a user to change out the detachable wings as desired, such as when the wings have been damaged through use. Given the harsh conditions that the wings endure, from both the elements and the attacks of predator fish, it is preferred to be able to easily swap them out as needed. One or more alignment holes may be punched into the one or more detachable wings, lining up with wing pin holes in the rigid wing slots within the lure body. The wings may be removably attached to the body by inserting a wing pin(s) into the wing pin holes, through the alignment holes of the detachable wings. Other mechanisms may be used to securely, but removeable, attach the wings, including, but not limited to, clips, slide clips, spring clips, friction clips, carbineers, snap hooks, trigger snap hooks, bolt snaps, quick links, lever snaps, hook and loop systems, and/or snap hooks.
Custom-painted detachable wings. Preferably, the wings may be made of stiff, but somewhat flexible, polycarbonate plastic. To ensure accuracy and reproducibility in the wing shape and size, a computer numerical control (“CNC”) machine may be used.
A recessed fishing line/hook channel. The body of the fishing lure may comprise a channel, which may be directly molded into the top of the lure body. To use the lure, an operator need simply fit the fishing line and hook(s) into the channel, ensuring that the fishing line and hook(s) are positioned perfectly and securely for each use.
A fishing line guide loop. The fishing line guide loop allows the lure to slide freely on the fishing line after a fish has bitten the lure. Preferably, the fishing line/hook rig may be secured to the lure with break-away plastic bands that break off when a fish bites the lure, allowing the lure to move freely on the line and away from the fish. This improves hook retention in two ways: (1) by preventing the fish from leveraging the weight of the lure to dislodge the hooks, and (2) preserving the integrity of the lure itself, by getting it away from the teeth of the fish.

One embodiment may be a fish lure, comprising: a body portion; and one or more wings. The one or more wings may be configured to be engaged with the body portion. The fish lure is configured to resemble a bait that is attractive to a one or more types of predatory fish. The one or more wings may be configured to be detachable from, and reattachable to, the body portion. When the one or more wings are attached to the body portion, the fish lure is configured to resemble a California Flying Fish that is gliding above water. The body portion comprises a head, a tail, and fishing line guide loop, wherein the fishing guide loop may be a closed loop that is configured to slidingly engage with a fishing line. The fishing guide loop may be secured proximate to a top of the head of the body portion. The body portion further comprises one or more wing supports that may be configured to engage with the one or more wings. The one or more wing supports may be substantially rigid and may be located substantially enclosed within the body portion. The one or more wing supports may further comprise one or more wing insertion slots that may be configured to removeably engage with the one or more wings. The one or more wing insertion slots may be curved, such that when the one or more wings are inserted into the one or more wing insertion slots, the one or more wings may be curved and may substantially have an airfoil shape. The one or more wing insertion slots may be accessible through an opening in an outer surface of the body portion. The airfoil shape of the one or more wings, when inserted into the one or more wing insertion slots, generates lift when the fish lure is trolled behind a boat via the fishing line at sufficient speeds. The fish lure may also comprise one or more wing pins, which may be configured to removeably secure the one or more wings into the one or more wing insertion slots. The body portion may further comprise a channel, that may be configured to receive one or more fishing hooks, which may be connected to the fishing line. The one or more wings may be decorated in a pattern and color matching a wing-like pectoral fin of a California Flying Fish. The body portion may be constructed from a durable material and may be painted in a pattern and color matching a natural coloration of the California Flying Fish. The fish lure is configured to be trolled behind a boat that is equipped with a fishing kite, such that the fish lure emulates a gliding movement of the California Flying Fish.

Another embodiment may be a flying fish lure, comprising: a body portion, which may comprise a head, a tail, and one or more wing supports; one or more detachable wings; and a fishing line guide loop, which is configured to be securely engaged with the body portion; wherein the fish lure is configured to resemble a California Flying Fish that is gliding above water that is attractive to a one or more types of predatory fish; wherein the fishing guide loop may be secured proximate to a top of the head of the body portion; wherein the one or more wing supports are substantially rigid and comprise one or more wing insertion slots; wherein the one or more detachable wings may be configured to removeably engage with the one or more wing insertion slots; wherein the one or more wing insertion slots are curved, such that when the one or more wings are inserted into the one or more wing insertion slots, the one or more detachable wings are curved and substantially have an airfoil shape; wherein the airfoil shape of the one or more detachable wings when inserted into the one or more wing insertion slots generates lift when the fish lure is trolled behind a boat via the fishing line at sufficient speeds; wherein the body portion may further comprise a channel that may be configured to receive one or more fishing hooks, which are connected to the fishing line. The one or more wings may be decorated in a pattern and color matching a wing-like pectoral fin of a California Flying Fish. The body portion may be constructed from a durable material and may be painted in a pattern and color matching a natural coloration of the California Flying Fish. The fish lure may be configured to be trolled behind a boat that is equipped with a fishing kite, such that the fish lure emulates a gliding movement of the California Flying Fish.

Another embodiment may be a method of fishing using a realistic flying fish lure, comprising the steps: providing a flying fish lure; wherein the flying fish lure comprises a body portion and one or more wings; wherein the body portion comprises a fishing line guide loop and a channel; providing a fishing line that is connected to one or more hooks; threading the fishing line through the fishing line guide loop; engaging the one or more hooks with the body portion, such that an end of the fishing line is engaged with the flying fish lure; wherein a start of the fishing line is connected to a boat; passing the fishing line through a tension release clip; wherein the tension release clip is connected to a kite line; wherein two ends of the kite line are connected to a fishing kite and a boat, such that one or more portion of the fishing line are held aloft by the kite line; trolling the flying fish lure via the boat; and attaining sufficient speeds by the boat such that the flying fish lure glides and skips across a surface of a body of water.

Other features and advantages are inherent in the method of refreshing roasted coffee that is claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is an illustration of a perspective view of one embodiment of the realistic flying fish lure engaged with a fishing line and hooks.

FIG. 2 is an illustration of an exploded top plan view the realistic flying fish lure.

FIG. 3 is an illustration of a top plan view of the realistic flying fish lure.

FIG. 4 is an illustration of a close-up side view of the realistic flying fish lure, showing a wing slot for holding a detachable wing.

FIG. 5 is an illustration of a kite fishing system using a realistic flying fish lure.

FIG. 6 is a flowchart of the steps of constructing the realistic flying fish lure of the present disclosure.

FIG. 7 is a photo of one embodiment of the realistic flying fish lure.

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, these embodiments may be practiced without some or all of these specific details. In other instances, well-known methods, procedures, and/or components have not been described in detail so as not to unnecessarily obscure aspects of the embodiments.

While multiple embodiments are disclosed, still others will become apparent to those skilled in the art from the following detailed description. As will be realized, these embodiments are capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signified both in relation to the other endpoint, and independently of the other endpoint.

“Optional” or “optionally” means that the subsequently described event or circumstance may or may not occur, and that the description includes instances where the event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments. It is to be understood that the methods and systems are not limited to specific methods, specific components, or to particular implementations. It is also to be understood that the terminology used herein is for the purpose of describing particular embodiments only and is not intended to be limiting.

In the following description, certain terminology is used to describe certain features of one or more embodiments. For purposes of the specification, unless otherwise specified, the term “flying fish lure” or “realistic flying fish lure” generally refers to a life-like, reusable lure with detachable wings that imitates the features of a flying fish, and particularly the California Flying Fish.

“Trolling” refers to a method of fishing wherein one or more fishing lines are baited with lures or bait fish and drawn through the water.

“Fishing kite” refers to a specialized kite used for fishing, wherein the kite is flown behind a boat with forward momentum, as a means for providing lift to bait or a lure at the end of a fishing line that is also attached to the fishing kite.

Embodiments of the present disclosure generally relate to the field of fishing processes, devices, systems, and methods. More specifically, the present disclosure relates to fishing processes involving a realistic flying fish lure, wherein the flying fish lure includes detachable wings that provide lift when the flying fish lure is trolled behind a moving boat.

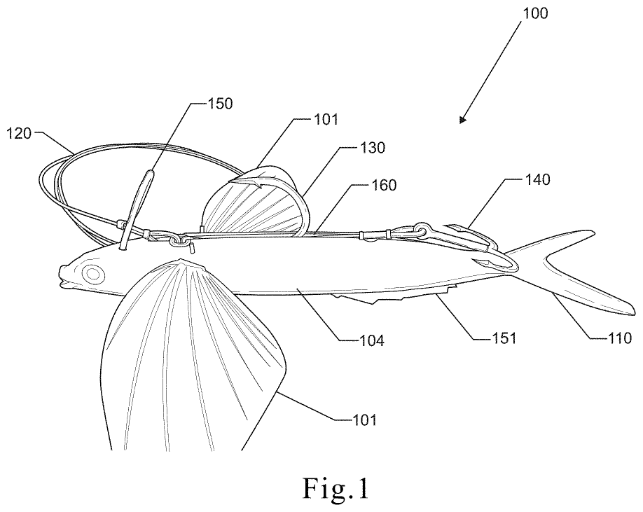

FIG. 1 is an illustration of a perspective view of one embodiment of the realistic flying fish lure engaged with a fishing line and hooks. As shown in FIG. 1, the flying fish lure 100 may comprise a body portion 104, one or more detachable wings 101, secondary fins 151, and a forked tail 110. The body portion 104 may include a top-side channel 160, which provides a slot into which a J-hook 130 and a treble hook 140 may be placed and held securely, but removeably via friction. The J-hook 130 and the treble hook 140 may be attached to a fishing line 120, allowing the hooks 130, 140 and the flying fish lure 100 to be reeled in after a fish has taken (bit into) the flying fish lure 100 as bait and become hooked onto the J-hook 130 and/or the treble hook 140. To help keep the fishing line 120 in place within the channel 160, the fishing line 120 may be threaded through a line guide loop 150 prior to being placed into the channel 160. The channel 160 may include one or more recessed hook slot/notch positions, allowing the J-hook 130 and treble hook 140 to be perfectly positioned every time the flying fish lure 100 is used. The line guide loop 150 is preferably near a head of the lure and it may also act to secure the lure 100 to the fishing line if the hooks 130, 140 become dislodged from the channel 160. This allows the lure 100 to remain outside of the mouth of the predatory fish after the lure is taken as bait.

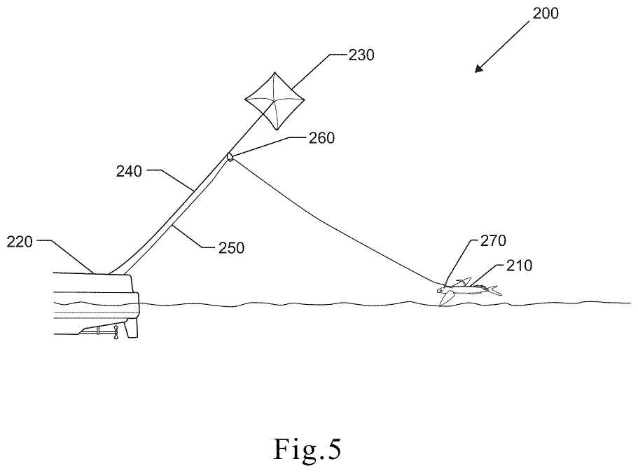

The detachable wings 101 may be selectively removed from the body portion 104 of the flying fish lure 100, allowing them to be easily repaired and/or replaced as they sustain damage from fish bites or other wear. In some instances, the detachable wings 101 may break away from the body portion 104 due to the force of a bite, which helps improve the chances of a successful hookup. While in use, the detachable wings 101 serve to greatly enhance the realism of the flying fish lure 100 in two distinct ways. First, the detachable wings 101 make the flying fish lure 100 closely match the real-life appearance of the California Flying Fish, including its silhouette as seen by predators beneath the water's surface. Second, the when the flying fish lure 100 is trolled behind a boat, the wings provide lift that helps the flying fish lure 100 to “fly” above the surface of the water, mimicking the movement patterns of a living California Flying Fish. FIG. 5 provides a more detailed visualization of the lift provided by the detachable wings 101 as the flying fish lure 100 is trolled behind a boat.

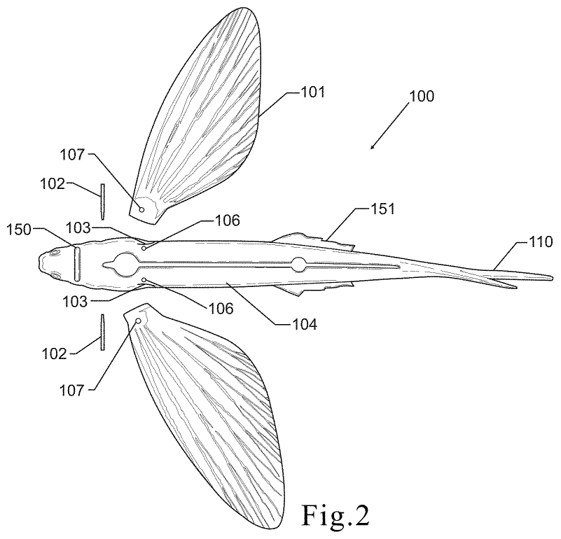

FIG. 2 is an illustration of an exploded top plan view the realistic flying fish lure. FIG. 2 is an illustration of a top plan view of a flying fish lure 100 with its detachable wings 101 removed. As shown in FIG. 2, the detachable wings 101 may be freely removed and attached to the main body portion 104 by means of a pair of wing pins 102. The detachable wings may be inserted laterally into the body portion 104 by means of a pair of wing slots 103 in the side of the body portion 104. After inserting the detachable wings 101 into the wing slots 103, the detachable wings 101 may be locked in position by means of the wing pins 102.

In one embodiment, to lock the detachable wings 101 in place, the detachable wings 101 are first inserted into the wing slots 103 located on the side of the body portion 104. Next, the wing pins 102 are inserted into the wing pin holes 106, such that the wing pins 102 pass into or through the body portion 104 and a pair of alignment holes 107 punched into the detachable wings 101. The pins may be held in place by friction. By aligning the wing pins 102 with both the wing pin holes 106 and the alignment holes 107, the detachable wings 101 are securely locked in position so long as the wing pins 102 remain in position. To ensure that the detachable wing 101 stays firmly in position, the wing pin 102 preferably passes at least half an inch past the alignment hole 107 after insertion. In this manner, the combination of wing pins 102, wing pin holes 106, wing slots 103, and alignment holes 107 allow the detachable wings 101 to be securely and removably attached to the body portion 104 of the flying fish lure 100.

To remove the detachable wings 101 from the body portion 104, the wing pins 102 need simply be removed by pulling them out of the body portion 104. Once the wing pins 102 have been removed, the detachable wings 101 may be pulled out of their respective wing slots 103 in like manner as they were initially inserted.

In other embodiments, there may be a single wing that passes through the wing slot and is held in place by pins, snaps, friction, or other connecting mechanisms. In other embodiments, the wings may be collapsible and/or hangable into the sides of the body portion of the lure.

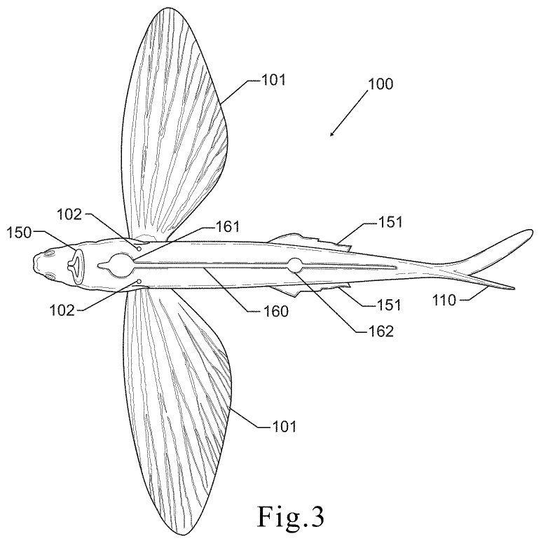

FIG. 3 is an illustration of a top plan view of the realistic flying fish lure. FIG. 3 is a top plan illustration of a flying fish lure 100 with the detachable wings 101 attached to the body portion. As shown in FIG. 3, the assembled flying fish lure 100 closely resembles the California Flying Fish once its detachable wings 101 have been secured in place via wing pins 102. In addition to the detachable wings 101, the flying fish lure 100 may further improve its mimicry of the California Flying Fish by including secondary fins 151 and a forked tail 110. The body portion 104 may preferably be made of a rubber-urethane mixture, which provides flexibility and long-term stability. Both the body portion 104 and detachable wings 101 may be painted, such as with an airbrush, to enhance the life-like appearance of the flying fish lure 100.

In some embodiments, the channel 160 may further comprise a J-hook notch 161 and a treble hook notch 162, into which the J-hook 130 and treble hook 140 may be placed, respectively. The channel 160, J-hook notch 161, and treble hook notch 162 enable hooks and fishing line to be consistently placed into the flying fish lure 100 in the proper position, while also making them less visibly apparent to the predatory fish. The J-hook notch 161 and treble hook notch 162 additionally help to keep the weight of the lure 100 optimally balanced for the line-tie connection.

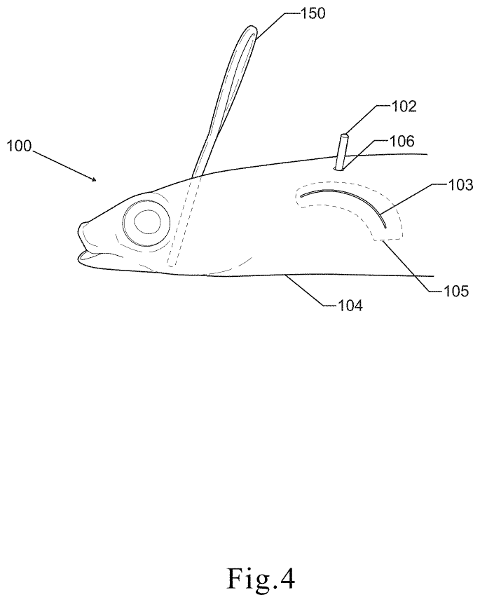

FIG. 4 is an illustration of a close-up side view of the realistic flying fish lure, showing a wing slot for holding a detachable wing. FIG. 4 is a close-up illustration of a flying fish lure 100, with the detachable wings 101 removed. As shown in FIG. 4, the body portion 104 of the flying fish lure 100 may further comprise one or more wing supports 105 and one or more wing pin holes 106. While most of the body portion 104 may be flexible (being made of, for example, rubber and/or urethane), the wing supports 105 (which is shown in broken line because it is an internal structure) may preferably be made of a durable rigid material, such as plastic. The rigidity of the wing supports 105 may keep the detachable wings 101 locked into place, once the detachable wings 101 are inserted into the wing slots 103 of the wing supports 105 and the wing pins 102 are inserted into the body portion 104.

Additionally, the rigidity of the wing supports 105 helps to bend or curve the detachable wings 101 into an appropriate curved and shaped airfoil shape for generating lift when forward momentum is present, such as when trolled behind a boat at sufficient speed. As seen in FIG. 4, the wing supports 105 may be enclosed within the body portion 104, and the body portion may have a wing slot 103, which may be visible, and which allows the wing supports receive a detachable wing 101. The detachable wing 101 is preferably slightly curved or bent in order to be inserted into the wing slot 103, causing the detachable wing 101 to be bent into a curved airfoil shape which maximizes lift as the flying fish lure 100 is pulled along the surface of the water by the forward momentum of a boat.

FIG. 5 is an illustration of a kite fishing system using a realistic flying fish lure. FIG. 5 is an illustration of a fishing system 200 using a flying fish lure and a fishing kite. As shown in FIG. 5, the fishing system 200 may comprise a flying fish lure 210, a boat 220, a fishing kite 230, a kite line 240, a fishing line 250, a tension release clip 260, and a line guide loop 270. The kite line 240 connects at each end to the boat 220 and the fishing kite 230, respectively, while the fishing line 250 connects to the boat 220 and the flying fish lure 210. The tension release clip 260 may be attached to a point on the kite line 240 between the boat 220 and the fishing kite 230, and provides an opening through which the fishing line 250 may be run on its way to the flying fish lure 210. The fishing kite 230 may be a specialty lightweight fishing kite that is designed to generate lift and tension in the kite line 240 as forward momentum is supplied by the boat 220.

As the boat 220 moves forward in the water, the forward momentum creates lift for the fishing kite 230, such that the fishing kite 230 holds the kite line 240 taut at an angle ranging from approximately 30° to 60° relative to the water's surface. As the fishing kite 230 lifts and holds taut the kite line 240, the resulting tension is transferred to the flying fish lure 210 via the fishing line 250 and the tension release clip 260. The upward lift supplied to the flying fish lure 210 by the fishing line 250 (and the detachable wings) help the flying fish lure to glide and/or skip along the surface of the water, mimicking the swimming pattern of a live California Flying Fish. This entices predators to take the bait and bite onto the flying fish lure 210. Preferably, the detachable wings may be shaped into an airfoil, by means of the curved wing slots in the body portion of the flying fish lure 210. At sufficient speeds attained by the boat 220, the flying fish lure 210 appears to and/or actually does skim, glide, and/or skip gracefully across the water's surface. When a predator fish bites the lure and is hooked, the substantial pressure or force applied by the bite is transferred to the fining line 250, which causes the tension release clip 260 to open and release the fishing line 250 from being held aloft by the kite line 240. Once the fishing line 250 has been released, the hooked predator fish may then be reeled in normally. The line guide loop 270 on the head portion of the flying fish lure 210 allows the flying fish lure 210 to slide freely up the fishing line 250 after being bit by a predator fish. Preferably, in addition to friction, the fishing line 250 and hook rig may be secured to the lure 210 with breakaway plastic bands, such that when a fish bites the lure, the bands break off and the lure 210 may move slidably on the fishing line 250 via line guide loop 270. Preferably, once the hook rig is embedded in the caught fish, the lure 210 may move out of the mouth of the caught fish, yet still connected to the line 250 via loop 270, such that lure 210 is out of harms way and fully recoverably to be used again.

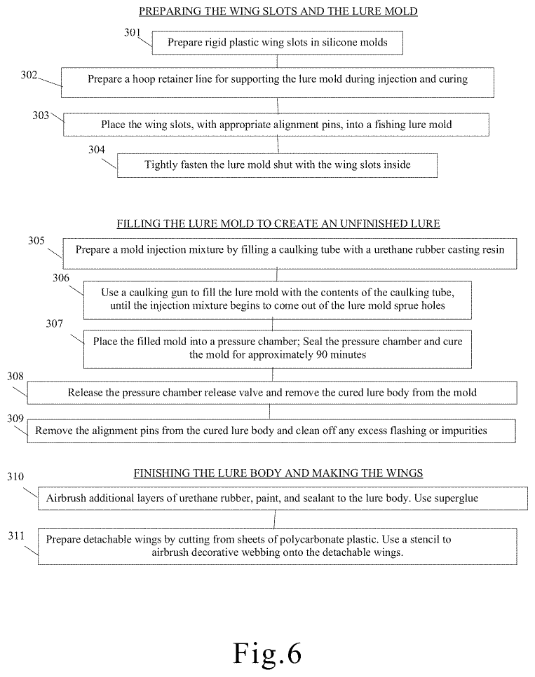

FIG. 6 is a flowchart of the steps of constructing the realistic flying fish lure of the present disclosure. FIG. 6 is a flow diagram outlining an exemplary method for a flying fish lure manufacturing process 300. As shown in FIG. 6, the flying fish lure manufacturing process 300 may comprise the following steps:

### Preparing the Rigid Wing Slots and the Lure Mold for Injection

All times, weights, temperatures, and materials are approximate. At step 301, the wing supports 105 are prepared by pouring a two-part thermal set plastic into appropriately shaped silicone molds. After three minutes of curing, the left and right wing supports 105 may be popped out of their respective molds. Before proceeding any further, any excess flashing should be scraped off the wing supports 105. The supports may be a single unitary piece in some embodiments.

At step 302, a custom hoop line retainer is prepared using a 400-lb test monofilament chafe tubing, along with a stainless-steel crimp and stainless-steel washer. The hoop line retainer components are assembled, while crimps are used to lock it together. The hoop line retainer helps provide structural support during the molding injection process.

At step 303, the left and right wing supports 105 and alignment pins are inserted into a two-part lure mold. Preferably, the lure mold includes alignment slots to assist with positioning the wing supports 105 and alignment pins in their appropriate positions. At this stage, the hoop line retainer should be inserted into the designated alignment slot in the lure mold.

Next, at step 304, the two halves of the lure mold are closed together and fastened tightly (such as with rubber bands) to create a tight seal.

### Filling the Lure Mold to Create an Unfinished Lure

With the wing slots 103 having been inserted into the closed lure mold, the mold is ready to be filled to create the body portion 104 of a flying fish lure 100. At step 305, an injection mixture is prepared by mixing parts “A” and “B” of the Alumilite Flex Series urethane rubber in a 1:1 ratio by weight, approximately 150 grams of each part, and pouring the resulting mixture into an empty caulking tube.

At step 306, the urethane rubber injection mixture is injected into the closed lure mold via a caulking gun, until the injection mixture begins to come out of the lure mold sprue vent holes.

At step 307, the filled lure mold is placed into a customized pressure pot to cure. Before curing, the wing nuts on the lid of the pressure pot should be tightly sealed. The pressure pot should be connected to an air compressor and 50 PSI pressurized tank, with the connecting valve between the pressure pot and tank opened. Allow the filled lure mold to cure inside the pressurized tank for approximately 90 minutes.

At step 308, the pressure tank valve is released to relieve pressure, allowing the now-cured lure mold to be removed. Additionally, the lure mold is disassembled, such that the now-cured lure body portion 104 may be removed.

At step 309, the alignment pins and wing slot alignment pieces are removed from the cured rubber body portion 104. Preferably, a modified soldering iron may be used to melt away any excess flashing that may be present on the molding seam line, to provide a more uniform appearance for the body portion 104. Additionally, an acetone-saturated wipe, such as a paper towel, may be used to wipe away any residual mold release or impurities remaining on the body portion 104 from the molding process.

### Finishing the Lure Body Portion and Making the Wings

Though the body portion 104 has been prepared, it still needs to be painted to more closely resemble a real California Flying Fish. To that end, at step 310, an airbrush gun may be used spray two-part urethane rubber directly onto the lure body portion 104, ideally in one light coating. Immediately afterward, the body portion 104 should be sprayed with one or more urethane paints to create the desired realistic paint scheme. Next, three light top coats of TC90 Urethane Rubber should be sprayed over the House of Colors urethane paint layer to seal in the color. Finally, add a drop of super glue to the recessed eye socket on the body portion 104, and place the premade eye into position. At this point, the body portion 104 is now complete.

At step 311, the detachable wings 101 may be cut from sheets of polycarbonate plastic using a CNC (computer numerical control) machine. The precision of the CNC machine makes it possible to finely match the curvature of the California Flying Fish's wings. After the detachable wings 101 have been cut out, a stencil may be used to airbrush a decorative webbing pattern onto the detachable wings 101 to more closely match the appearance of a real fish.

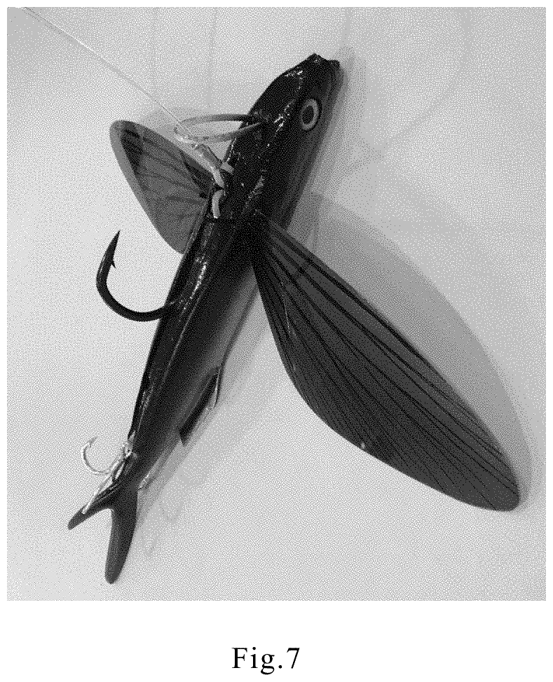

FIG. 7 is a photo of one embodiment of the realistic flying fish lure. As shown in FIG. 7, the realistic flying fish lure may have a very realistic paint job and realistic eye that are optimized to convince a predatory fish that the lure is actually a real California Flying Fish.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection is not limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A fish lure, comprising:
a body portion; and
one or more wings;
wherein said one or more wings are configured to be engaged with said body portion; and
wherein said fish lure is configured to resemble a bait that is attractive to a one or more types of predatory fish.

2. The fish lure of claim 1, wherein said one or more wings are configured to be detachable from, and reattachable to, said body portion.

3. The fish lure of claim 2, wherein when said one or more wings are attached to said body portion, said fish lure is configured to resemble a California Flying Fish that is gliding above water.

4. The fish lure of claim 2, wherein said body portion comprises a head, a tail, and fishing line guide loop;
wherein said fishing guide loop is a closed loop that is configured to slidingly engage with a fishing line.

5. The fish lure of claim 4, wherein said fishing guide loop is secured proximate to a top of said head of said body portion.

6. The fish lure of claim 2, wherein said body portion further comprises one or more wing supports that are configured to engage with said one or more wings

7. The fish lure of claim 6, wherein said one or more wing supports are substantially rigid and are located substantially enclosed within said body portion.

8. The fish lure of claim 7, wherein said one or more wing supports further comprise one or more wing insertion slots that are configured to removeably engage with said one or more wings.

9. The fish lure of claim 8, wherein said one or more wing insertion slots are curved, such that when said one or more wings are inserted into said one or more wing insertion slots, said one or more wings are curved and substantially have an airfoil shape.

10. The fish lure of claim 9, wherein said one or more wing insertion slots are accessible through an opening in an outer surface of said body portion.

11. The fish lure of claim 9, wherein said airfoil shape of said one or more wings when inserted into said one or more wing insertion slots generates lift when said fish lure is trolled behind a boat via said fishing line at sufficient speeds.

12. The fish lure of claim 9, further comprising one or more wing pins, which are configured to removeably secure said one or more wings into said one or more wing insertion slots.

13. The flying fish lure of claim 4, wherein said body portion further comprises a channel.

14. The fish lure of claim 13, wherein said channel is configured to receive one or more fishing hooks, which are connected to said fishing line.

15. The fish lure of claim 14, wherein said one or more wings are decorated in a pattern and color matching a wing-like pectoral fin of a California Flying Fish;
wherein said body portion is constructed from a durable material and is painted in a pattern and color matching a natural coloration of said California Flying Fish.

16. The flying fish lure of claim 15, wherein said fish lure is configured to be trolled behind a boat that is equipped with a fishing kite, such that said fish lure emulates a gliding movement of said California Flying Fish.

17. A flying fish lure, comprising:
a body portion, which comprises a head, a tail, and one or more wing supports;
one or more detachable wings; and
a fishing line guide loop, which is configured to be securely engaged with said body portion;
wherein said fish lure is configured to resemble a California Flying Fish that is gliding above water that is attractive to a one or more types of predatory fish;
wherein said fishing guide loop is secured proximate to a top of said head of said body portion wherein said one or more wing supports are substantially rigid and comprise one or more wing insertion slots;
wherein said one or more detachable wings care configured to removeably engage with said one or more wing insertion slots;
wherein said one or more wing insertion slots are curved, such that when said one or more wings are inserted into said one or more wing insertion slots, said one or more detachable wings are curved and substantially have an airfoil shape;
wherein said airfoil shape of said one or more detachable wings when inserted into said one or more wing insertion slots generates lift when said fish lure is trolled behind a boat via said fishing line at sufficient speeds;
wherein said body portion further comprises a channel that is configured to receive one or more fishing hooks, which are connected to said fishing line.

18. The fish lure of claim 17, wherein said one or more wings are decorated in a pattern and color matching a wing-like pectoral fin of a California Flying Fish;
wherein said body portion is constructed from a durable material and is painted in a pattern and color matching a natural coloration of said California Flying Fish.

19. The flying fish lure of claim 15, wherein said fish lure is configured to be trolled behind a boat that is equipped with a fishing kite, such that said fish lure emulates a gliding movement of said California Flying Fish.

20. A method of fishing using a flying fish lure, comprising the steps:
providing a flying fish lure;
wherein the flying fish lure comprises a body portion and one or more wings;
wherein said body portion comprises a fishing line guide loop and a channel;
providing a fishing line that is connected to one or more hooks;
threading said fishing line through said fishing line guide loop;
engaging said one or more hooks with said body portion, such that an end of said fishing line is engaged with said flying fish lure;
wherein a start of said fishing line is connected to a boat;
passing said fishing line through a tension release clip;
wherein said tension release clip is connected to a kite line;
wherein two ends of said kite line are connected to a fishing kite and a boat, such that one or more portion of the fishing line are held aloft by said kite line;
trolling said flying fish lure via said boat; and
attaining sufficient speeds by said boat such that said flying fish lure glides and skips across a surface of a body of water.
